(19) United States
(12) Patent Application Publication
(10) Pub. No.: US 2016/0366666 A1
(43) Pub. Date: Dec. 15, 2016

(54) WIRELESS NETWORK COMMUNICATIONS EMPLOYING AN EXTENDED CONTROL CHANNEL

(71) Applicants: Rongzhen Yang, Shanghai (CN); Po-Kai Huang, Santa Clara, CA (US); Qinghua Li, San Ramon, CA (US); Peng Meng, Shanghai (CN); Hujun Yin, Saratoga, CA (US)

(72) Inventors: Rongzhen Yang, Shanghai (CN); Po-Kai Huang, Santa Clara, CA (US); Qinghua Li, San Ramon, CA (US); Peng Meng, Shanghai (CN); Hujun Yin, Saratoga, CA (US)

(21) Appl. No.: 14/868,437

(22) Filed: Sep. 29, 2015

Related U.S. Application Data
(60) Provisional application No. 62/173,792, filed on Jun. 10, 2015.

(51) Int. Cl. H04W 72/00

(52) U.S. Cl. CPC H04W 72/005

(57) ABSTRACT

Provided are systems for identifying content to be provided in broadcast or multicast, broadcasting a communication including an indication that the content is provided in downlink data as well as downlink data including the content.

### CROSS-REFERENCE TO RELATED APPLICATIONS

This application claims priority to and benefit of U.S. Patent Application Ser. No. 62/173,792 filed on Jun. 10, 2015, and entitled “Systems and Methods for Wireless Network Communications Employing Extended Control Channel.” The disclosure of the aforementioned application is entirely incorporated herein by reference.

### TECHNICAL FIELD

This application relates to wireless networks.

### BACKGROUND

A next generation wireless local area network (WLAN) standard, IEEE 802.11ax or High-Efficiency WLAN (HEW), is under development. The standard employs a first and second high-efficiency signal field A (HE-SIG-A) and B (HE-SIG-B). The fields can be used to communicate various types of information, although the capacity of the fields may be limited.

### BRIEF DESCRIPTION OF THE DRAWINGS

FIG. 1 is a block diagram that illustrates an example network environment in accordance with one or more example embodiments of the disclosure.

FIG. 2 illustrates a frame structure including an explicit resource indication of extended high-efficiency signal field B (HE-SIG-B) content in accordance with one or more example embodiments of the disclosure.

FIG. 3 illustrates a frame structure including an explicit resource indication of extended HE-SIG-B content in a common part of HE-SIG-B in accordance with one or more example embodiments of the disclosure.

FIG. 4 illustrates an index of stream allocation including an explicit resource indication of extended HE-SIG-B content in a common part of HE-SIG-B in accordance with one or more example embodiments of the disclosure.

FIG. 5 illustrates a dedicated signaling segment of the common part including an explicit resource indication of extended HE-SIG-B content in a common part of HE-SIG-B in accordance with one or more example embodiments of the disclosure.

FIG. 6 illustrates a frame structure including an explicit resource indication of extended HE-SIG-B content in a wireless network station (STA) specific part of HE-SIG-B in accordance with one or more example embodiments of the disclosure.

FIG. 7 is a diagram that illustrates use of resource units (RUs) to provide an implicit resource indication of an extended HE-SIG-B area in accordance with one or more example embodiments of the disclosure.

FIGS. 8A and 8B are flow diagrams that illustrate methods for employing an extended HE-SIG B area in accordance with one or more example embodiments of the disclosure.

FIG. 9 is a block diagram that illustrates an example machine in accordance with one or more example embodiments of the disclosure.

FIG. 10 is a functional diagram that illustrates an example communication station in accordance with one or more example embodiments of the disclosure.

### DETAILED DESCRIPTION

The present embodiments will now be described more fully hereinafter with reference to the accompanying drawings in which exemplary embodiments are shown. Embodiments may, however, be provided in many different forms and should not be construed as limited to the illustrated embodiments set forth herein. Rather, these exemplary embodiments are provided so that this disclosure will be thorough and complete, and will fully convey the scope of the disclosure to those skilled in the art.

In some embodiments, systems and methods are provided for employing extended control channels with wireless communications. In some embodiments, broadcast control information is extended into a downlink data partition. The use of a data partition can enable the broadcast of a relatively large control payload. That is, for example, the data partition may be relatively large when compared to the size of other locations for broadcasting control information, thereby enable a larger amount of control information to be carried in the data partition. For example, if a high-efficiency signal field B (HE-SIG-B) includes a common part and a station (STA) specific part with fixed or limited symbols lengths then the payload capacity of those fields may be limited. This can be of particular concern where a large amount of information needs to be communicated, such as in the case of supporting the large number of assigned STAs for both downlink and uplink transmission, and/or when scheduling payload needs to carry both downlink and uplink schedules (e.g., when downlink-uplink cascading with different sets of STAs is supported).

In some embodiments, an additional control area is broadcast in a downlink data partition. The downlink data partition can be provided in addition to the first and second high-efficiency signal fields A (HE-SIG-A) and B (HE-SIG-B) and/or a standalone control frame. The additional control area maybe referred to as the “extended HE-SIG-B area.” The extended HE-SIG-B area can be used to carry control information, such as PHY (physical layer) control information, MAC (media access control) information, MAC management information, and/or the like.

In some embodiments, an indication of the extended HE-SIG-B area is provided explicitly (e.g., in an explicit resource indication of extended HE-SIG-B content). In some embodiments, an indication of the extended HE-SIG-B area is provided explicitly in a common part of HE-SIG-B (e.g., in a resource indication in common part of HE-SIG-B). This can include, for example, an indication in a special index of a stream allocation, in a dedicated signaling segment of the common part, and/or the like. In some embodiments, an indication of the extended HE-SIG-B area is provided explicitly in a STA specific part of HE-SIG-B (e.g., in a resource indication in STA specific part of HE-SIG-B). In some embodiments, an indication of the extended HE-SIG-B area is provided implicitly (e.g., in an implicit resource indication of extended HE-SIG-B content). This can include, for example, an indication of the extended HE-SIG-B area based on resource units (RUs) that are not assigned to any STAs.

Such embodiments (e.g., employing extended HE-SIG-B designs based on the current candidate IEEE 802.11 ax standard HE-SIG-B) can enable flexible resource allocation information into downlink data field with broadcast, and improve overall system performance (e.g., in the case of downlink-uplink cascading and large number of connected STAs, such as MTC (Machine Type Communication), IoT (The Internet of Things), M2M (Machine to Machine communication), and/or the like.

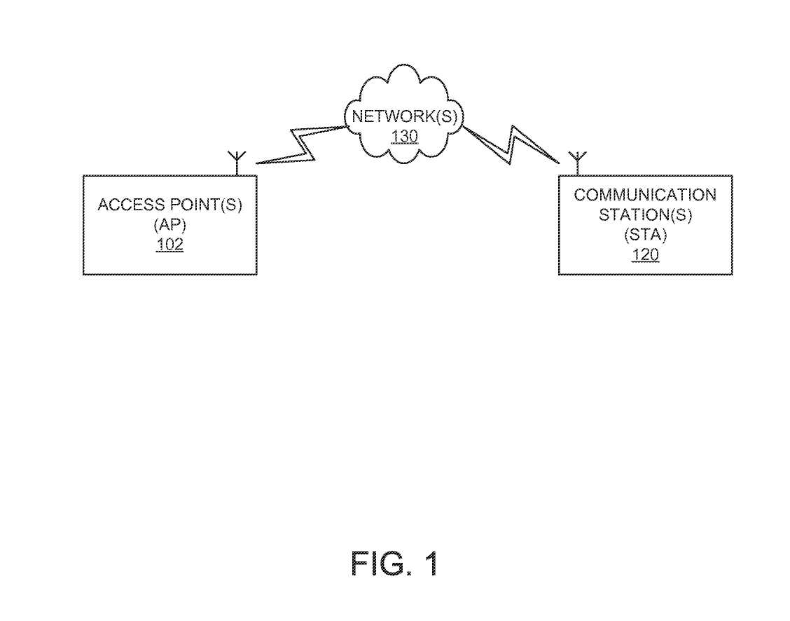

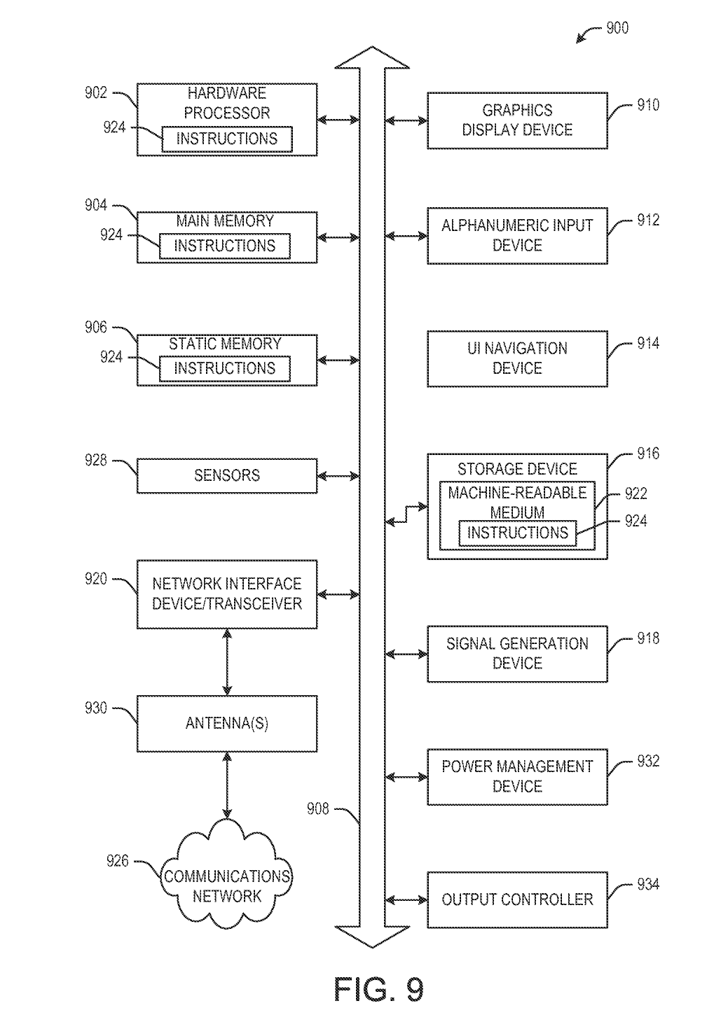

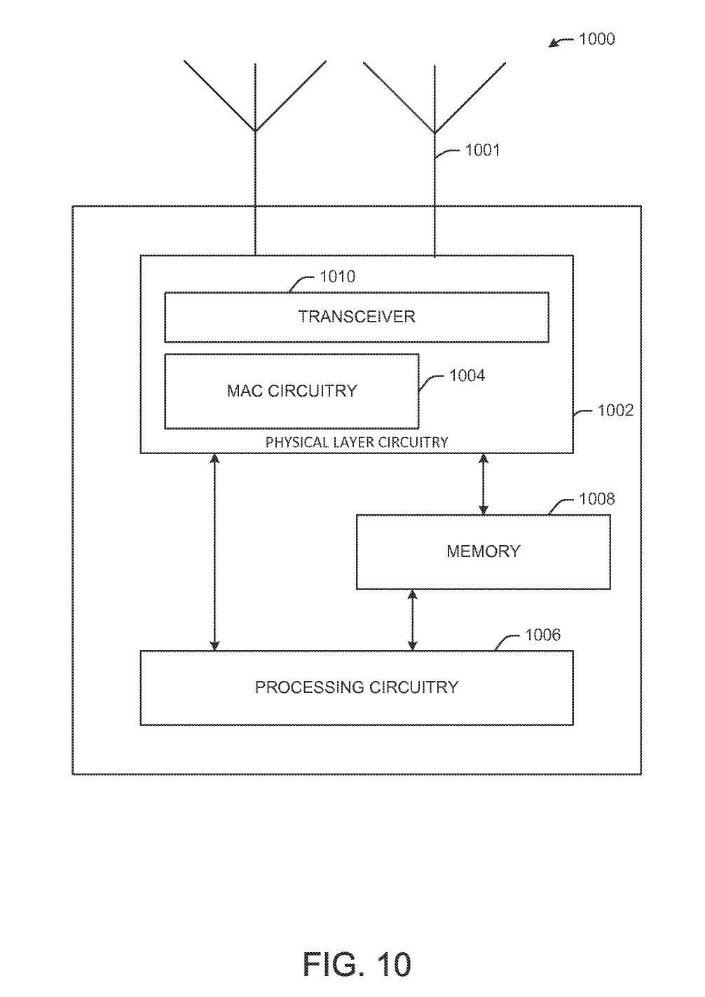

FIG. 1 is a block diagram illustrating an example wireless network environment (“wireless network”) 100 in accordance with one or more example embodiments of the disclosure. Wireless network 100 can include one or more wireless network stations (STAs) 120 (also referred to as “communication stations,” “stations” or “user devices”) and one or more access points (AP) 102, which may communicate in accordance with IEEE 802.11 communication standards, including IEEE 802.11 ax. The one or more stations 120 may comprise mobile computing devices that are non-stationary and do not have fixed locations. The one or more APs 102 may be stationary and have fixed locations. The one or more stations 120 may be operable by one or more users. A station 120 may include any suitable processor-driven user device including, but not limited to, a desktop computing device, a laptop computing device, a server, a router, a switch, a smartphone, a tablet, wearable wireless device (e.g., bracelet, watch, glasses, ring, etc.) and so forth. In some embodiments, the station(s) 120 and the AP(s) 102 can include one or more computer systems similar to that of the example machine/system of FIG. 9 and/or the functional diagram of FIG. 10.

In accordance with some IEEE 802.11ax (High-Efficiency WLAN (HEW)) embodiments, an access point may operate as a master station which may be arranged to contend for a wireless medium (e.g., during a contention period) to receive exclusive control of the medium for an HEW control period. The master station may transmit an HEW master-sync transmission at the beginning of the HEW control period. During the HEW control period, HEW stations may communicate with the master station in accordance with a non-contention based multiple access technique. This is unlike conventional Wi-Fi communications in which devices communicate in accordance with a contention-based communication technique, rather than a multiple access technique. During the HEW control period, the master station may communicate with HEW stations using one or more HEW frames. Furthermore, during the HEW control period, legacy stations refrain from communicating. In some embodiments, the master-sync transmission may be referred to as an HEW control and schedule transmission.

In some embodiments, the multiple-access technique used during the HEW control period may be a scheduled orthogonal frequency division multiple access (OFDMA) technique, although this is not a requirement. In other embodiments, the multiple access technique may be a time-division multiple access (TDMA) technique or a frequency division multiple access (FDMA) technique. In certain embodiments, the multiple access technique may be a space-division multiple access (SDMA) technique.

The master station may also communicate with legacy stations in accordance with legacy IEEE 802.11 communication techniques. In some embodiments, the master station may also be configurable to communicate with HEW stations outside the HEW control period in accordance with legacy IEEE 802.11 communication techniques, although this is not a requirement.

In some embodiments, the links of an HEW frame may be configurable to have the same bandwidth. The bandwidth may be one of 20 MHz, 40 MHz, or 80 MHz contiguous bandwidths or an 80+80 MHz (160 MHz) non-contiguous bandwidth. In some embodiments, a 320 MHz contiguous bandwidth may be used. In some embodiments, bandwidths of 5 MHz and/or 10 MHz may also be used. In these embodiments, each link of an HEW frame may be configured for transmitting a number of spatial streams.

Any of the stations 120 and the APs 102 may be configured to communicate with each other via one or more communications networks 130 wirelessly or wired. Any of the communications networks 130 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the stations 120 and the APs 102 may include one or more communications antenna. Communications antenna may be any suitable type of antenna corresponding to the communications protocols used by the station(s) 120, and the AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the stations 120.

Any of the stations 120 and the APs 102 may include any suitable radio and/or transceiver for transmitting and/or receiving radio frequency (RF) signals in the bandwidth and/or channels corresponding to the communications protocols utilized by any of the stations 120 and the APs 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

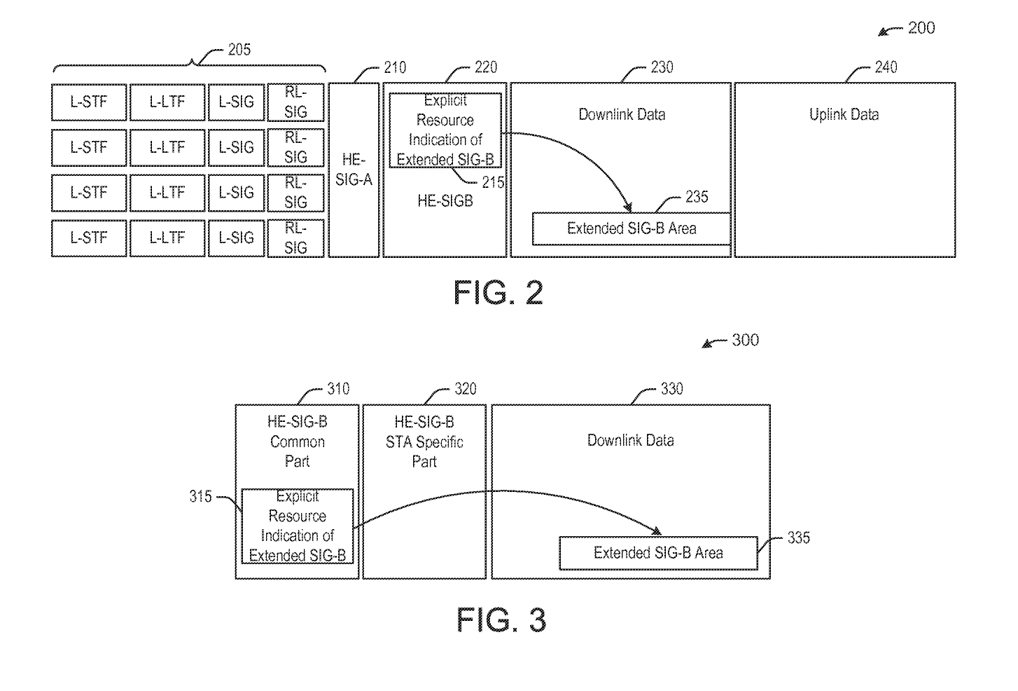

FIG. 2 illustrates a frame structure 200 including an explicit resource indication of extended HE-SIG-B content in accordance with one or more example embodiments of the disclosure. The frame structure 200 may include a number of training and signaling fields 205 that may include a number of legacy short training fields (L-STF), legacy long training fields (L-LTF), legacy signal fields (L-SIG) and repeated legacy signal fields (RL-SIG). The frame structure 200 may further include a HE-SIG-A area 210, a HE-SIG-B area 220, downlink data 230 and uplink data 240.

The HE-SIG-B area 220 may include an explicit resource indication 215 of an extended SIG-B area 235 which is in the downlink data 230. The explicit resource indication 215 of the extended SIG-B area 235 will be described in greater detail below.

The overall frame structure shown in FIG. 2 may be the IEEE 802.11ax OFDMA/MU-MIMO frame structure. In some embodiments, an abstract concept description can allow the explicit resource indication of an extended SIG-B to tell all connected STAs about the information of a broadcast extended SIG-B. As described herein, in some embodiments, an indication of the extended HE-SIG-B area is provided explicitly in a common part of HE-SIG-B (e.g., in a resource indication in a common part of HE-SIG-B). This can include, for example, an indication in a special index of a stream allocation, in a dedicated signaling segment of the common part, and/or the like.

Further, as described herein, in some embodiments, an indication of the extended HE-SIG-B area can be provided explicitly in a STA specific part of an HE-SIG-B (e.g., in a resource indication in STA specific part of HE-SIG-B).

FIG. 3 illustrates a frame structure 300 including an explicit resource indication of extended HE-SIG-B content in a common part of HE-SIG-B in accordance with one or more example embodiments of the disclosure. The frame structure 300 may include a HE-SIG B common part 310, an HE-SIG-B station (STA) specific part 320 and downlink data 330.

The HE-SIG-B common part 310 may include an explicit resource indication 315 of an extended SIG-B area 335 which is in the downlink data 335. The explicit resource indication 315 of the extended SIG-B area 335 will be described in greater detail below.

In some embodiments, the HE-SIG-B can be designed as having at least two parts: (1) a common part; and (2) a STA specific part. The common part may carry information that is shared by all scheduled STAs to avoid the duplication in the STA specific part. The STA specific part may carry the specific information such as broadcast access ID (AID) and a modulation and coding scheme (MCS) of each STA for downlink (or uplink) transmission.

In some embodiments, the explicit resource indication of extended HE-SIG-B content can indicate the presence of and/or the location of the content in the extended SIG-B area. In some embodiments, an explicit resource indication can include an indication in a special index of a stream allocation, can be provided in a dedicated signaling segment of the common part, and/or the like.

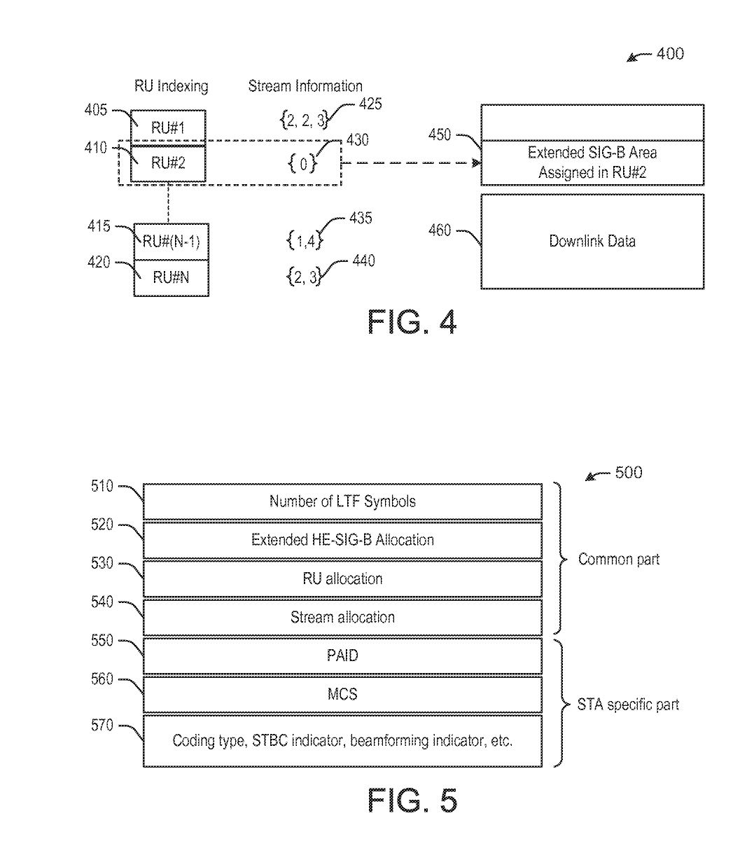

FIG. 4 illustrates an index of a stream allocation 400 including an explicit resource indication of extended HE-SIG-B content in a common part of HE-SIG-B in accordance with one or more example embodiments of the disclosure. The stream allocation 400 may include a number of frequency sub-bands 405, 410, 415 and 420. The stream allocation 400 may further include a number of stream allocation index values 425, 430, 435 and 440 that correspond to the frequency sub-bands 405, 410, 415 and 420.

The stream allocation 400 may further include an extended SIG-B area 450 which, as shown by the dashed lines surrounding the frequency sub-band 410 and the stream allocation index value 430, may be assigned in the frequency sub-band 410. The stream allocation 400 may further include downlink data 460.

In some embodiments, to integrate with targeting for joint resource unit (RU)/Stream allocation, a resource indication of the extended HE-SIG-B area 450 can be indicated by a special stream allocation index value (e.g., 15 (1,1,1,1) or 0 (0,0,0,0) in a 4 bit expression) as illustrated in FIG. 4. For example, in the illustrated embodiment of FIG. 4, the frequency sub-band 410 (i.e., RU#2) is allocated for the extended SIG-B area (or control channel) 450 and it is indicated by the stream allocation index value 430 (having an indication value of 0). When a receiver sees the 0 index, it can determine that the sub-band or RU is for broadcasting.

The special stream allocation index can be 0 or some other specific pre-defined value that can be separated from a meaningful stream index value. Since index 0 may be used for unallocated RU, index 15 with all ones may be more suitable in some conditions. Such an embodiment can provide flexibility. For example, one or more broadcast control channels can be provided using a pre-defined special stream allocation index. Moreover, in some instances, several multi-cast control channels can be defined and assigned to several STAs by pre-defined specific stream allocation indexes and pre-signaled broadcast messages.

FIG. 5 illustrates various segments in an HE-SIG-B 500. The segments include a long training field frequency segment 510, an extended HE-SIG-B allocation segment 520, an RU allocation segment 530, a stream allocation segment 540, a partially broadcast access ID (PAID) segment 550, a modulation and coding scheme (MCS) segment 560 and a coding type, a space-time block coding (STBC), beamforming indicator, etc. segment 570. As shown in FIG. 5, in some embodiments, the segments 510-540 may comprise a common part of the HE-SIG-B 500 and the segments 550-570 may comprise a specific part of the HE-SIG-B 500.

In some embodiments, the extended HE-SIG-B allocation segment 520 may be a dedicated signaling segment including an explicit resource indication of extended HE-SIG-B content in the common part of the HE-SIG-B 500 in accordance with one or more example embodiments of the disclosure. In some embodiments, a new signaling segment (e.g., “extended HE-SIG-B allocation”) can be added into the common part of HE-SIG-B. It should be appreciated that the HE-SIG-B allocation segment 520 is not limited to the illustrated location (e.g., the new added segment may be before or after the RU allocation segment 530).

In some embodiments, the extended HE-SIG-B allocation segment 520 in the common part may specify which sub-band or RU is allocated for broadcasting. In some embodiments, the modulation and coding scheme (MCS) of the extended HE-SIG-B area (or control channel) can be specified (e.g., along with the frequency location and/or bandwidth). Since the extended HE-SIG-B area may already be provided in the common part of the HE-SIG-B 500, the HE-SIG-B specific part may not include a further indication (e.g. AID and MCS) for that sub-band or RU.

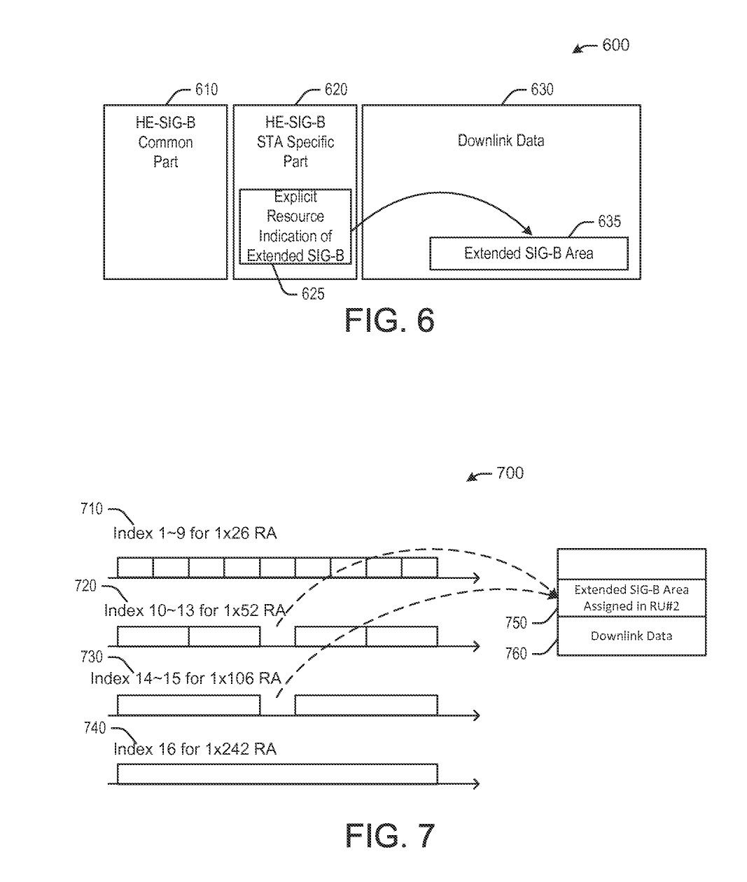

FIG. 6 illustrates a frame structure 600 including an explicit resource indication of extended HE-SIG-B content in a STA specific part of HE-SIG-B in accordance with one or more example embodiments of the disclosure. The frame structure 600 may include may include a HE-SIG B common part 610, a HE-SIG-B station (STA) specific part 620 and downlink data 630.

The HE-SIG-B STA specific part 620 may include an explicit resource indication 625 of an extended SIG-B area 635 which is in the downlink data 630. The explicit resource indication 625 of the extended SIG-B area 635 will be described in greater detail below.

In some embodiments, a broadcast access ID (AID) or partially AID (PAID) can be defined (e.g., in a specification), and each STA can check the broadcast AID or PAID assignment (e.g., in addition to checking its own STA specific AID assignment), in the processing of the HE-SIG-B STA specific part 620. In some embodiments, each STA can check two AIDs for receiving information targeted to the STA.

As noted above, in some embodiments, an indication of the extended HE-SIG-B area 635 can be provided explicitly in a STA specific part of HE-SIG-B (e.g., in a resource indication in STA specific part of HE-SIG-B). In some instances of RU indexing, some OFDMA resources are difficult to use for resource allocation (e.g., due to a current IEEE 802.11ax standard development of OFDMA design). For example, a middle 26-tone RU straddling a DC tone may be too small for any STA and it is suitable for control message. In some embodiments, RUs can be used as an implicit or default resource indication for the extended HE-SIG-B area 635. For example, RUs may be used as the extended HE-SIG-B area 635 unless they are allocated to a STA.

FIG. 7 is a diagram 700 that illustrates the use of RUs to provide an implicit resource indication of an extended HE-SIG-B area in accordance with one or more example embodiments of the disclosure. The diagram 700 includes indexes 710, 720, 730 and 740. The diagram 700 also includes extended SIG-B area 750 and downlink data 760.

FIG. 7 illustrates a 20 MHz OFDMA index as one example. In some embodiments, when a 20 MHz OFDMA resource is indexed (i.e., as indexes 710-740) and then assigned, and/or the center 1×26 RU or (RA) have not been assigned to any STAs, it is considered an implicit indication of the extended HE-SIG-B area. That is, the presence of the extended HE-SIG-B area can be implied when it is determined that the 20 MHz OFDMA resource is indexed and then assigned, and/or the center 1×26 RU or (RA) have not been assigned to any STAs. The resource allocation of a control channel may be any size and, thus, is not limited to 26 tones. In some embodiments, the resource allocation of a control channel may be decided by the resource unassigned explicitly to any STAs.

In some embodiments, decoding of extended HE-SIG-B can be a consideration. For example, if a STA cannot decode more than one RU assignment simultaneously, then a STA may decode the control channel information only if there is no other resource allocation for that STA in the STA specific part. In other words, if there is signaling for a particular STA A in the STA specific part, then the STA A may not decode the control channel. Further, if a STA can decode more than one RU assignment simultaneously, then the STA may decode both the control channel information and the resource allocation for that STA in the STA specific part. In the event that a STA cannot decode more than one RU assignment simultaneously, the content in the control channel (i.e., the extended control channel) will not include control channel information for a STA if there are additional RUs (i.e., not including the RU allocated to the control channel) that are allocated to the STA.

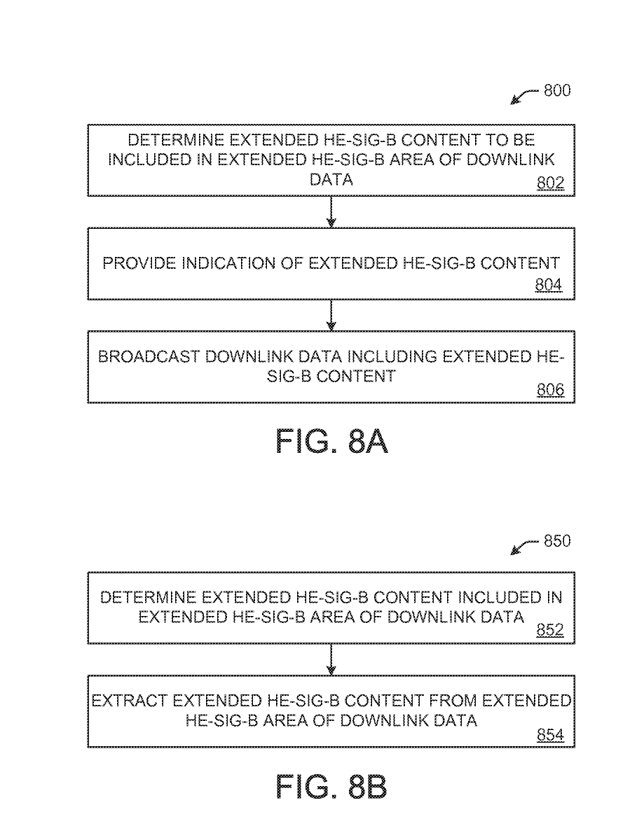

FIG. 8A is a flow diagram that illustrates an example method 800 for employing an extended HE-SIG B area in accordance with one or more example embodiments of the disclosure. Some or all of the elements of method 800 may be performed, for example, by a transmitting device. Method 800 may include determining extended HE-SIG-B content to be included in an extended HE-SIG-B area of downlink data (block 802). This can include, for example, determining PHY control information, MAC control information, MAC management information, any MAC multicast/broadcast frame, a MAC trigger frame for uplink multi-user (UL-MU) operation, to be included in extended HE-SIG-B area of downlink data. Method 800 may include providing an indication of extended SIG-B content (block 804). In some embodiments, providing an indication of extended SIG-B content can include providing an explicit indication of the extended HE-SIG-B area. This can include, for example, broadcasting a HE-SIG-B field that includes an indication of the extended HE-SIG-B area as described herein. For example, an indication can be provided explicitly in a common part of HE-SIG-B (e.g., in a resource indication in common part of HE-SIG-B). This can include, for example, an indication in a special index of a stream allocation, in a dedicated signaling segment of the common part, and/or the like. In some embodiments, an indication of the extended HE-SIG-B area can be provided explicitly in a STA specific part of HE-SIG-B (e.g., in a resource indication in STA specific part of HE-SIG-B). In some embodiments, providing an indication of extended SIG-B content can include providing an implicit indication of the extended HE-SIG-B area (e.g., in an implicit resource indication of extended HE-SIG-B content). This can include, for example, an indication of the extended HE-SIG-B area based on resource units (RUs) that are not assigned to any STAs. Method 800 may include broadcasting downlink data including the extended HE-SIG-B content (block 806). This can include, for example, broadcasting downlink data that includes the PHY control information, MAC control information, MAC management information, any MAC multicast/broadcast frame, a MAC trigger frame for uplink multi-user (UL-MU) operation, and/or the like.

FIG. 8B is a flow diagram that illustrates an example method 850 for employing an extended HE-SIG B area in accordance with one or more example embodiments of the disclosure. Some or all of the elements of method 850 may be performed, for example, by a receiving device (e.g., a receiving STA). Method 850 may include determining that extended HE-SIG-B content is included in an extended HE-SIG-B area of downlink data (block 852). For, example, a device receiving a broadcast or multicast including downlink data may determine that the downlink data includes extended HE-SIG-B based on an explicit indication received (e.g., in the common or STA specific part of the HE-SIG-B field of the broadcast or multicast) and or an implicit indication received (e.g., implicitly indicated by use of RUs) as described herein. Method 850 may include extracting extended HE-SIG-B content from the extended HE-SIG-B area of the downlink data (block 854). For example, the receiving STA may extract the PHY control information, MAC control information, MAC management information, any MAC multicast/broadcast frame, a MAC trigger frame for uplink multi-user (UL-MU) operation, and/or the like from the extended HE-SIG-B area.

It will be appreciated that the methods are exemplary embodiments of methods that may be employed in accordance with the techniques described herein. The methods may be modified to facilitate variations of their implementations and uses. The order of the methods and the operations provided therein may be changed, and various elements may be added, reordered, combined, omitted, modified, etc. The methods may be implemented in software, hardware, or a combination thereof. Some or all of the methods may be implemented by one or more of the devices/modules/applications described herein.

FIG. 9 is a block diagram that illustrates an example machine (or system) 900 in accordance with one or more example embodiments of the disclosure. Some or all of the techniques (e.g., methodologies) discussed herein may be performed on such a machine 900. In other embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a power management device 932, a graphics display device 910, an alphanumeric input device 912 (e.g., a keyboard), and a user interface (UI) navigation device 914 (e.g., a mouse). In an example, the graphics display device 910, alphanumeric input device 912 and UI navigation device 914 may be a touch screen display. The machine 900 may additionally include a storage device (i.e., drive unit) 916, a signal generation device 918 (e.g., a speaker), a network interface device/transceiver 920 coupled to antenna(s) 930, and one or more sensors 928, such as a global positioning system (GPS) sensor, compass, accelerometer, or other sensor. The machine 900 may include an output controller 934, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine-readable media.

While the machine-readable medium 922 is illustrated as a single medium, the term “machine readable medium” may include a single medium or multiple media (e.g., a centralized or distributed database, and/or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine-readable medium examples may include solid-state memories, and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible media to facilitate communication of such software.

FIG. 10 is a functional diagram illustrating an example communication station 1000 in accordance with one or more example embodiments of the disclosure. In one embodiment, FIG. 10 illustrates a functional block diagram of a communication station that may be suitable for use as an AP 102 (see FIG. 1) or communication station 120 (see FIG. 1) in accordance with some embodiments. The communication station 1000 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 1000 may include physical layer circuitry 1002 having a transceiver 1010 for transmitting and receiving signals to and from other communication stations using one or more antennas 1001. The physical layer circuitry 1002 may also include medium access control (MAC) circuitry 1004 for controlling access to the wireless medium. The communication station 1000 may also include processing circuitry 1006 and memory 1008 arranged to perform the operations described herein. In some embodiments, the physical layer circuitry 1002 and the processing circuitry 1006 may be configured to perform operations detailed herein.

In accordance with some embodiments, the MAC circuitry 1004 may be arranged to contend for a wireless medium and configure frames or packets for communicating over the wireless medium and the physical layer circuitry 1002 may be arranged to transmit and receive signals. The physical layer circuitry 1002 may include circuitry for modulation/demodulation, upconversion/downconversion, filtering, amplification, etc. In some embodiments, the processing circuitry 1006 of the communication station 1000 may include one or more processors. In other embodiments, two or more antennas 1001 may be coupled to the physical layer circuitry 1002 arranged for sending and receiving signals. The memory 1008 may store information for configuring the processing circuitry 1006 to perform operations for configuring and transmitting message frames and performing the various operations described herein. The memory 1008 may include any type of memory, including non-transitory memory, for storing information in a form readable by a machine (e.g., a computer). For example, the memory 1008 may include a computer-readable storage device may, read-only memory (ROM), random-access memory (RAM), magnetic disk storage media, optical storage media, flash-memory devices and other storage devices and media.

In some embodiments, the communication station 1000 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1000 may include one or more antennas 1001. The antennas 1001 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1000 may include one or more of a keyboard, a display, a non-volatile memory port, multiple antennas, a graphics processor, an application processor, speakers, and other mobile device elements. The display may be an LCD screen including a touch screen.

Although the communication station 1000 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1000 may refer to one or more processes operating on one or more processing elements.

Certain embodiments may be implemented in one or a combination of hardware, firmware and software. Other embodiments may also be implemented as instructions stored on a computer-readable storage device, which may be read and executed by at least one processor to perform the operations described herein. The instructions may be in any suitable form, such as but not limited to source code, compiled code, interpreted code, executable code, static code, dynamic code, and the like. A computer-readable storage device or medium may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1000 may include one or more processors and may be configured with instructions stored on a computer-readable storage device memory.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation. As used throughout this application, the singular forms “a, “an,” and “the” include plural referents unless the content clearly indicates otherwise. Thus, for example, reference to “an element” may include a combination of two or more elements. As used throughout this application, the phrase “based on” does not limit the associated operation to being solely based on a particular item. Thus, for example, processing “based on” data A may include processing based at least in part on data A and based at least in part on data B unless the content clearly indicates otherwise. Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

According to example embodiments of the disclosure, there may be a device comprising: one or more processors; and one or more memory devices storing program instructions that are executable by the one or more processors to: identify content to be provided in a broadcast or multicast; and broadcast a communication comprising: an indication that the content is provided in downlink data; and the downlink data comprising the content. In example embodiments, the device may include a radio or transceiver having one or more antennas. In further example embodiments, the indication comprises an explicit indication that the content is provided in the downlink data. In still further example embodiments, the communication is a high-efficiency signal field B (HE-SIG-B) and the indication that the content is provided in downlink data is provided explicitly in the HE-SIG-B. In some further example embodiments, the indication is a resource indication in a common part of the HE-SIG-B. In some further example embodiments, the indication is provided in an index of a stream allocation or a dedicated segment of the common part of the HE-SIG-B. In some further example embodiments, the indication is a resource indication in a station specific part of the HE-SIG-B. In some further example embodiments, the indication is an implicit indication that the content is provided in downlink data. The implicit indication is an indication of an extended HE-SIG-B area based on unassigned station resource units (RUs).

According to example embodiments of the disclosure, there may be a computer-readable non-transitory storage medium that contains instructions, which when executed by one or more processors, result in performing operations comprising: identifying content to be provided in a broadcast or multicast; and causing to broadcast a communication comprising: an indication that the content is provided in downlink data; and the downlink data comprising the content. In example embodiments, the indication comprises an explicit indication that the content is provided in the downlink data. In still further example embodiments, the communication is a high-efficiency signal field B (HE-SIG-B) and the indication that the content is provided in downlink data is provided explicitly in the HE-SIG-B. In some further example embodiments, the indication is a resource indication in a common part of the HE-SIG-B. In some further example embodiments, the indication is provided in an index of a stream allocation or a dedicated segment of the common part of the HE-SIG-B. In some further example embodiments, the indication is a resource indication in a station specific part of the HE-SIG-B. In some further example embodiments, the indication is an implicit indication that the content is provided in downlink data. The implicit indication is an indication of an extended HE-SIG-B area based on unassigned station resource units (RUs).

According to example embodiments of the disclosure, there may be a device comprising: one or more processors; and one or more memory devices storing program instructions that are executable by the one or more processors to: receive a broadcast or multicast communication comprising: an indication that content is provided in downlink data; and the downlink data comprising the content; determine that the content is provided in the downlink using the indication; and extract the content from the downlink data. In example embodiments, the device may include a radio or transceiver having one or more antennas. In further example embodiments, the communication is a high-efficiency signal field B (HE-SIG-B). In still further example embodiments, the indication that the content is provided in downlink data is provided explicitly in the HE-SIG-B. In some further example embodiments, the indication is a resource indication in a common part of the HE-SIG-B. In some further example embodiments, the indication is provided in an index of a stream allocation or a dedicated segment of the common part of the HE-SIG-B. In some further example embodiments, the indication is a resource indication in a station specific part of the HE-SIG-B.

According to example embodiments of the disclosure, there may be a computer-readable non-transitory storage medium that contains instructions, which when executed by one or more processors, result in performing operations comprising: receiving a broadcast or multicast communication comprising: an indication that content is provided in downlink data; and the downlink data comprising the content; determining that the content is provided in the downlink data using the indication; and causing to extract the content from the downlink data. In example embodiments, the communication is a high-efficiency signal field B (HE-SIG-B). In still further example embodiments, the indication that the content is provided in downlink data is provided explicitly in the HE-SIG-B. In some further example embodiments, the indication comprises a resource indication in a common part of the HE-SIG-B. In some further example embodiments, the indication is a resource indication in a station specific part of the HE-SIG-B.

According to example embodiments of the disclosure, there may be a method. The method may include identifying content to be provided in a broadcast or multicast; and broadcasting a communication comprising: an indication that the content is provided in downlink data; and the downlink data comprising the content. In example embodiments, the indication comprises an explicit indication that the content is provided in the downlink data. In still further example embodiments, the communication is a high-efficiency signal field B (HE-SIG-B) and the indication that the content is provided in downlink data is provided explicitly in the HE-SIG-B. In some further example embodiments, the indication is a resource indication in a common part of the HE-SIG-B. In some further example embodiments, the indication is provided in an index of a stream allocation or a dedicated segment of the common part of the HE-SIG-B. In some further example embodiments, the indication is a resource indication in a station specific part of the HE-SIG-B. In some further example embodiments, the indication is an implicit indication that the content is provided in downlink data. The implicit indication is an indication of an extended HE-SIG-B area based on unassigned station resource units (RUs).

According to example embodiments of the disclosure, there may be a method. The method may include receiving a broadcast or multicast communication comprising: an indication that content is provided in downlink data; and the downlink data comprising the content; determining that the content is provided in the downlink using the indication; and extracting the content from the downlink data. In example embodiments, the communication is a high-efficiency signal field B (HE-SIG-B). In still further example embodiments, the indication that the content is provided in downlink data is provided explicitly in the HE-SIG-B. In some further example embodiments, the indication is a resource indication in a common part of the HE-SIG-B. In some further example embodiments, the indication is provided in an index of a stream allocation or a dedicated segment of the common part of the HE-SIG-B. In some further example embodiments, the indication is a resource indication in a station specific part of the HE-SIG-B.

According to example embodiments of the disclosure, there may be a means for identifying content to be provided in a broadcast or multicast; and broadcasting a communication comprising: an indication that the content is provided in downlink data; and the downlink data comprising the content. In example embodiments, the indication comprises an explicit indication that the content is provided in the downlink data. In still further example embodiments, the communication is a high-efficiency signal field B (HE-SIG-B) and the indication that the content is provided in downlink data is provided explicitly in the HE-SIG-B. In some further example embodiments, the indication is a resource indication in a common part of the HE-SIG-B. In some further example embodiments, the indication is provided in an index of a stream allocation or a dedicated segment of the common part of the HE-SIG-B. In some further example embodiments, the indication is a resource indication in a station specific part of the HE-SIG-B. In some further example embodiments, the indication is an implicit indication that the content is provided in downlink data. The implicit indication is an indication of an extended HE-SIG-B area based on unassigned station resource units (RUs).

According to example embodiments of the disclosure, there may be a means for receiving a broadcast or multicast communication comprising: an indication that content is provided in downlink data; and the downlink data comprising the content; determining that the content is provided in the downlink using the indication; and extracting the content from the downlink data. In example embodiments, the communication is a high-efficiency signal field B (HE-SIG-B). In still further example embodiments, the indication that the content is provided in downlink data is provided explicitly in the HE-SIG-B. In some further example embodiments, the indication is a resource indication in a common part of the HE-SIG-B. In some further example embodiments, the indication is provided in an index of a stream allocation or a dedicated segment of the common part of the HE-SIG-B. In some further example embodiments, the indication is a resource indication in a station specific part of the HE-SIG-B.

What is claimed is:

1. A device, comprising:
one or more processors; and
one or more memory devices storing program instructions that are executable by the one or more processors to:
identify content to be provided in a broadcast or multicast; and
broadcast a communication comprising:
an indication that the content is provided in downlink data; and
the downlink data comprising the content.

2. The device of claim 1, wherein the indication comprises an explicit indication that the content is provided in the downlink data.

3. The device of claim 1, wherein the communication comprises a high-efficiency signal field B (HE-SIG-B), and wherein the indication that the content is provided in downlink data is provided explicitly in the HE-SIG-B.

4. The device of claim 3, wherein the indication comprises a resource indication in a common part of the HE-SIG-B.

5. The device of claim 1, further comprising a radio.

6. The device of claim 5, wherein the radio comprises one or more antennas.

7. The device of claim 1, wherein the indication comprises an implicit indication that the content is provided in downlink data, the implicit indication comprising an indication of an extended HE-SIG-B area based on unassigned station resource units (RUs).

8. A computer-readable non-transitory storage medium that contains instructions, which when executed by one or more processors result in performing operations comprising:
identifying content to be provided in a broadcast or multicast; and
causing to broadcast a communication comprising:
an indication that the content is provided in downlink data; and
the downlink data comprising the content.

9. The medium of claim 8, wherein the indication comprises an explicit indication that the content is provided in the downlink data.

10. The medium of claim 8, wherein the communication comprises a high-efficiency signal field B (HE-SIG-B), and wherein the indication that the content is provided in downlink data is provided explicitly in the HE-SIG-B.

11. The medium of claim 10, wherein the indication comprises a resource indication in a common part of the HE-SIG-B.

12. The medium of claim 10, wherein the indication is provided in at least one of an index of a stream allocation and a dedicated segment of a common part of the HE-SIG-B.

13. The medium of claim 12, wherein the indication comprises a resource indication in a station specific part of the HE-SIG-B.

14. The medium of claim 10, wherein the indication comprises an implicit indication that the content is provided in downlink data, the implicit indication comprising an indication of an extended HE-SIG-B area based on unassigned station resource units (RUs).

15. A device, comprising:
one or more processors; and
one or more memory devices storing program instructions that are executable by the one or more processors to:
receive a broadcast or multicast communication comprising:
an indication that content is provided in downlink data; and
the downlink data comprising the content;
determine that the content is provided in the downlink using the indication; and
extract the content from the downlink data.

16. The device of claim 15, wherein the communication comprises a high-efficiency signal field B (HE-SIG-B).

17. The device of claim 16, wherein the indication that the content is provided in downlink data provided explicitly in the HE-SIG-B.

18. The device of claim 16, wherein the indication comprises a resource indication in a common part of the HE-SIG-B.

19. The device of claim 15, further comprising a radio.

20. The device of claim 19, wherein the radio comprises one or more antennas.

21. A computer-readable non-transitory storage medium that contains instructions, which when executed by one or more processors result in performing operations comprising:
receiving a broadcast or multicast communication comprising:
an indication that content is provided in downlink data; and
the downlink data comprising the content;
determining that the content is provided in the downlink data using the indication; and
causing to extract the content from the downlink data.

22. The medium of claim 21, wherein the communication comprises a high-efficiency signal field B (HE-SIG-B).

23. The medium of claim 22, wherein the indication that the content is provided in downlink data is provided explicitly in the HE-SIG-B.

24. The medium of claim 22, wherein the indication comprises a resource indication in a common part of the HE-SIG-B.

25. The medium of claim 22, wherein the indication comprises a resource indication in a station specific part of the HE-SIG-B.
